(19) United States
(12) Patent Application Publication
(10) Pub. No.: US 2013/0259636 A1
(43) Pub. Date: Oct. 3, 2013

(54) DEVICES AND METHODS FOR HANDLING HAZARDOUS MATERIALS

(71) Applicant: Vincent F. Scheerer, Garden Ridge, TX (US)

(72) Inventor: Vincent F. Scheerer, Garden Ridge, TX (US)

(21) Appl. No.: 13/761,722

(22) Filed: Feb. 7, 2013

Related U.S. Application Data
(60) Provisional application No. 61/616,020, filed on Mar. 27, 2012.

(51) Int. Cl. B09B 5/00; A47B 96/02

(52) U.S. Cl. CPC B09B 5/00; A47B 96/025
USPC 414/807; 40/642.02; 414/800; 312/301

(57) ABSTRACT

The invention generally provides methods and devices for handling materials including the sorting or storing of waste. The invention further provides a modular materials handling and storage workstation unit for sensitive materials such as hazardous materials or waste common in a retail environment.

### CROSS-REFERENCE TO RELATED APPLICATION

This application claims priority to U.S. Provisional Patent Application No. 61/616,020, filed Mar. 27, 2012, the contents of which are incorporated by reference in their entirety.

### FIELD OF THE INVENTION

The present invention relates to hazardous waste storage and particularly to tools for handling waste as generated in a retail location for safe downstream handling.

### BACKGROUND

Retail establishments have to deal with waste that is hazardous. For example, many retailers sell cleaners, pesticides, or paints. When these products are damaged, returned, or recalled, the products and their packaging must then be treated as hazardous waste. To keep those wastes from the environment, and to comply with laws governing hazardous waste, retailers must carefully abide by strict protocols and best practices.

Some companies have no protocols. Employees are expected to use common sense in handling, for example, aerosols, fluorescent light bulbs, and chemicals, or such waste is thrown away with no regard for personal and environmental safety. Even with protocols, in some stores waste may be handled inconsistently and dangerously. Even a conscientious employee may sometimes disregard safe practices and instead do what seems easiest at the moment, such as tossing a can of bug spray into the trash.

Even though stores handle hazardous waste, some stores may have only a trash can sitting on the floor by a recycling tub. As a result, roach spray, broken light bulbs, and bleach may end up in groundwater and landfills. Such practices can lead to downstream pollution, injuries, or harm a company's reputation.

### SUMMARY

The invention provides devices and methods for handling and storing hazardous waste materials safely. Devices of the invention include a waste handling unit with interchangeable storage bins. The waste handling unit provides a work area and a storage area designed for retail hazardous waste. Storage bins are dimensioned to hold the most common retail hazardous wastes and the overall capacity of the unit is optimized to support commercially practicable pickup schedules by safely containing amounts of waste generated at a typical retail environment. Moreover, an insight of the invention is that retailers place a very high value on floor space and that adoption of a new device may depend on minimizing its footprint. Accordingly, a unit of the invention has good storage (e.g., 500 lbs.) along with a workspace and protective equipment storage, while having a minimal footprint. Use of the units makes the safe sorting and handling of waste easy, thus encouraging good practices. Since safely handling and storing waste at a workstation unit of the invention is easy, dangerous waste items are properly sequestered and contained, preventing exposure of people or the environment to hazardous wastes, either during handling or in downstream encounters in the environment at large.

Accordingly, the invention provides a materials handling workstation and storage unit. Units of the invention are modular and can be customized to a site. Units include a variety optional and interchangeable modules such as bins specifically designed for categories of materials, work station tools such as safety equipment; informational tools such as signs, books, binders, or computer devices; doors; panels; and lids, allowing the units to be installed as multi-purpose waste and material handling and storage stations. Materials handling units of the invention are particularly well-suited to be installed at a retail site such as, for example, a pharmacy, grocery store, home improvement store, or department store.

The invention includes the insights that use of a system may be adopted if it supports natural and intuitive work flow and also that many people intuitively and naturally work in a left-to-right manner. Accordingly, in certain embodiments, applicable signs and waste handling tools are arranged to be encountered in an appropriate order while progressing one's attention from left to right over the work area of the unit (alternatively, right-to-left if such circumstances prevail at a location). Since units of the invention include meaningful signage as well as waste handling tools organized in support of a logical work flow, units encourage good compliance and waste is sorted into appropriate bins so that it may be picked up during a service call quickly and efficiently.

In certain embodiments, the invention provides material sorting tools. A material sorting tool can include printed materials such as signs or books including illustrations or instructions. A material sorting tool can include a computer device, optionally including a scanner or camera, to aid in identifying a category of material and provide instructions for its handling. Material sorting tools can include gloves, tongs, safety goggles, absorbent pads, bags, or similar.

Methods and devices of the invention aid in sorting materials according to regulatory requirements and safety needs. Units provide a well-organized single point of pick up for outside service firms. In some embodiments, an outside service firm may provide a unit of the invention to a facility so that personnel at the facility can conveniently sort and prepare their materials for pickup. A service firm may have a pickup vehicle with corresponding collection units (e.g., larger bins to dump contents into, or equivalent empty bins to be “swapped out”), enabling quick, safe, and efficient pickup of materials from a facility.

In some embodiments, a computer device in a unit of the invention collects information about material as personnel handle and sort the material. The computer device can then provide information about the material to another device or entity, for example, a service firm taking custody of the material.

In certain aspects, the invention provides a device for handling materials including a plurality of compartments to receive and store different categories of material, in which each compartment comprises a safety feature specific to a category of waste, and a display to provide information about categories of waste and identify a compartment corresponding to each. In some embodiments, the storage bins are dimensioned to hold common hazardous waste packages standing in an upright position. For example, in some embodiments, each bin is dimensioned to hold six standard one-gallon bleach bottles standing in an upright position.

The device can optionally include a countertop work area, informational signage, “at the ready” compartments for tools or personal protective equipment (PPE), as well as customized absorbent liners or protective materials for handling and packaging materials. Other features included in a device or unit according to embodiments include a lid, security devices, power cords and/or outlet, light, solar cell, eye wash station, calculator, note pad, camera, computer, printer, Wi-Fi card or connection, infrared (IR) connection point, or other devices.

In certain embodiments, a unit or device of the invention includes instructional signage relating to the handling and disposal of waste, as well as “at the ready” pockets or compartments arranged in a natural progression (e.g., left to right) that provide the tools and materials for safe and effective handling of waste. For example, in some embodiments, a unit provides—from left to right—goggles and gloves for safety; bags that will contain waste; book, pamphlet, and sign display areas to give information about handling; a recessed work area fitted to hold a chemically absorbent pad; absorbent pads; and one or more storage bins. By looking at the signage, which can include information directing a person in safe waste handling, an employee of a retail company can safely and effectively handle, and properly sort numerous varieties of waste including, for example, used batteries, cosmetics, photodeveloper, paint, adhesives, tar or roofing materials, oils, pesticides or any other category of waste regularly handled by a firm.

In certain embodiments, the unit further includes a computer device comprising a memory coupled to a processor, wherein the processor is configured to receive information about a material and provide information about handling the material. The computer device can display information on a computer monitor, and can receive input through such means as a scanner, keyboard, mouse, barcode scanner, camera, touchscreen, or internet connection.

In certain aspects, the invention provides a method for handling materials including providing a device having a plurality of compartments, receiving at the device a plurality of materials of different categories, providing—via the device—information about the identity and categories of the plurality of materials and a compartment corresponding to each, and receiving each material into the corresponding compartment of the device.

### BRIEF DESCRIPTION OF THE DRAWINGS

FIG. 1 shows a modular unit according to certain embodiments of the invention.

FIG. 2 shows a modular unit according to certain embodiments of the invention.

FIG. 3 shows a work area with informational signage according to certain embodiments.

FIG. 4 shows a bin according to certain embodiments of the invention.

FIG. 5 shows a bin according to embodiments.

FIG. 6 shows a bin and its lid according to certain embodiments.

### DETAILED DESCRIPTION

The invention generally provides tools for the safe handling of waste and methods of safely and economically handling waste. Handling waste according to the invention includes protecting individuals, routing waste materials through a centralized point, sorting waste material, sequestering hazardous materials, and providing tools that make the safest procedure be the easiest procedure. Safety includes protecting individuals from direct harm and protecting human welfare by keeping dangerous pollutants from the environment at large.

The invention includes the insight that people will tend to act a certain way when tools are created and provided that make the safest behavior be the easiest or most logical behavior. Accordingly, the invention includes the recognition that existing waste collection tools and systems presented safety and cost problems. For example, a retail store may have a shelf for damaged returns and a trash compactor located in different locations and information visible at one does not direct a person on when, why, and how to use the other. According to the invention, one aspect of the problem is that existing waste collection tools are not easy to customize according to the waste of a particular environment (e.g., a retail site) and also require unique handling for each type of waste. For example, a pharmacist may have a collection vessel for controlled substances, but may not know what to do with a half-empty bottle of cleaner.

Thus the invention provides a unit for the handling of waste. Using a unit of the invention, it is the easy route to segregate the waste safely. A person is given a comfortable work area with an easy-to-clean surface. Due to the shape, accessibility, number, and locations of the information, bins, and tools, the easiest thing to do with each piece of waste will be the safest and waste will be handled according to well-designed protocols that avoid the need for costly downstream sorting. Downstream may make reference to a view of waste as proceeding as via a stream, in which a waste stream flows from a point at which waste is created, through a collection point and into transportation which may deposit waste into transfer stations (for more collection, sorting, or transportation) or for terminal disposal or storage. Under this view, the waste stream, upstream, and downstream may generally make reference to progress of waste through such a process.

In certain embodiments, a unit of the invention is a workstation that can be located in a workplace and integrated into the workflow. Such a workstation may include components, such as shelves, sidewalls, floor pan, or back wall, that can be assembled in place, e.g., according to local needs. In some embodiments, a unit of the invention is pre-assembled and can, for example, be delivered by truck and placed.

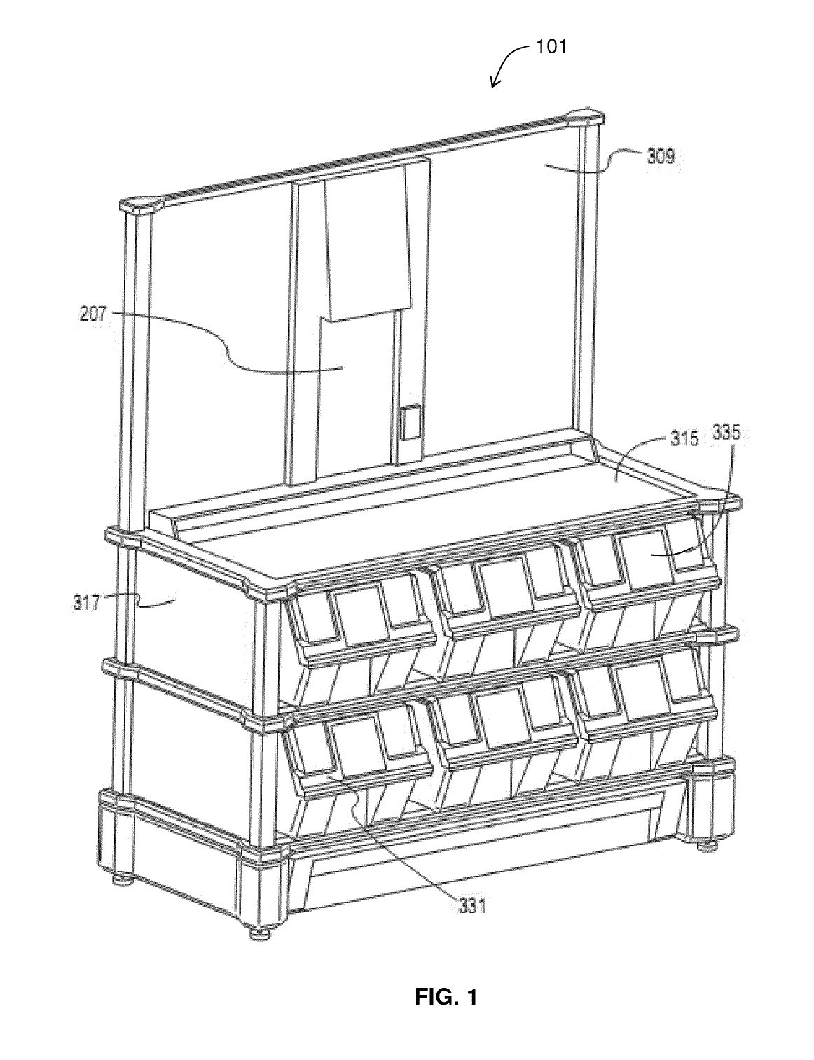

FIG. 1 shows a waste handling unit 101 of the invention. Unit 101 according to embodiments illustrated in FIG. 1 can include work area 315 and one or more of bin 331. Work area 315 provides a horizontal surface on which waste can be placed. Bin 331 can include information panel 335 (e.g., a clear card holder, sticker, or other display). Back panel 309 or side panel 317 can each include information displays. Area 207 can include pockets for pamphlets, personal protective equipment (PPE) such as gloves, goggles, or first aid materials, bags, tongs, or reagents.

Unit 101 may incorporate a modular design allowing various features or components to be interrelated (e.g., according to a “building block” design) or interchanged to present a unit suited to a particular installation. In this way, a waste handling station is provided that is customized for the location. Preferably, bins 331 are interchangeable to aid in storing and collecting waste. Interchangeable bins allow an employee to remove a full bin from the unit and insert an empty bin without exposing themselves to the hazardous materials contained in the full bin. Interchangeable bins further enable “pick up” methods that include removing a full bin and replacing it with an empty one, for example, from a truck. Waste storage is discussed in U.S. Pat. No. 7,617,113; U.S. Pat. No. 7,383,195; U.S. Pat. No. 7,126,480; and U.S. Pat. No. 7,138,918, the contents of each of which are incorporated by reference in their entirety.

Unit 101 may further incorporate information in the form of binders, printed pamphlets, or displays provided by signs or electronics. Provision of information tools or displays provides devices and systems extensible to retail environments such that non-professional personnel (store clerks, customers, etc.) can safely and effectively handle materials.

In some embodiments, the invention provides a unit 101 with a rectangular work area 315 in which the unit is configured to be positioned against a wall, in line with a counter so that work area 315 provides an extension of the counter, free standing, or a combination thereof. Unit 101 may have feet, for example, with rubberized surfaces that face downwards, to prevent motion. One or a number of bin 331 can be provided that can be inserted and removed from one of the long sides of the unit so that the unit is configured and positioned such that a user may stand facing the long side and place waste materials on surface 315 and have access to any of bin 331.

In some embodiments, unit 101 includes specific tools to aid in the safe handling of waste. For example, unit 101 may include absorbent pad landing 367 where materials can undergo extensive handling (e.g., disassembly, washing, rupturing of capsules, scraping, disinfecting, rinsing with a solvent) disposed in such a way that user has a convenient flat, smooth work surface, for example. Absorbent pad landing 367 can also provide an absorbent pad to sequester target materials (e.g., polluting liquids) and prevent them from entering a the environment. An absorbent pad can then be bagged or disposed of separately, ensuring safe and environmentally friendly disposal of materials. Extra absorbent pads can be provided in caddy 377, along with storage 371 for books, instructions, handling tools, etc.

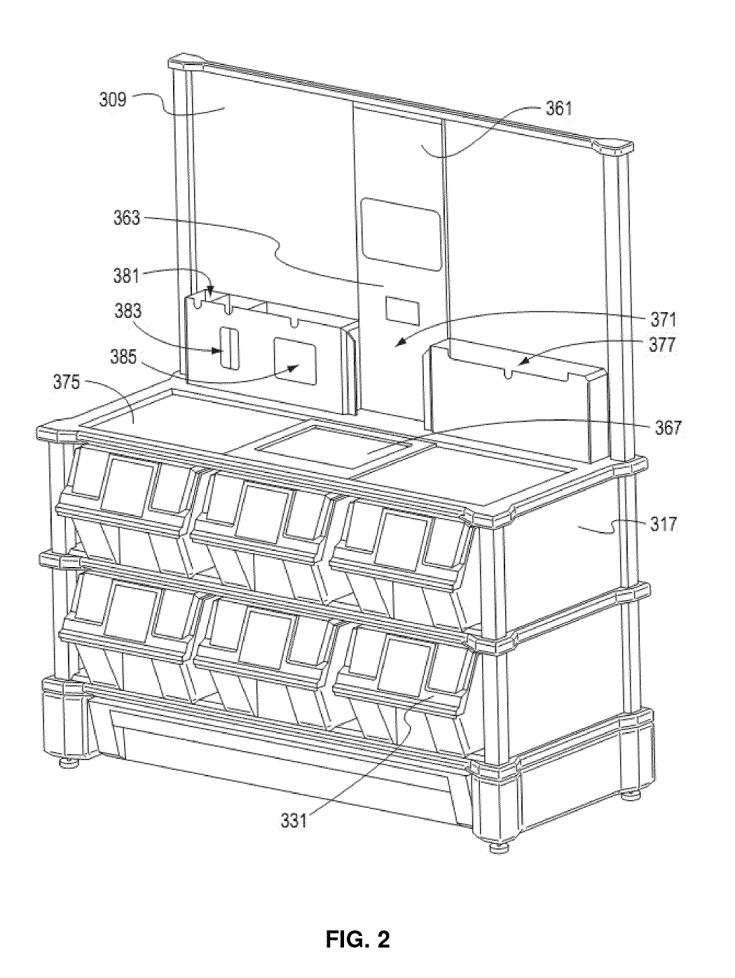

FIG. 2 shows another view of unit 101. A recessed work area 375 can be provided, for example, to prevent sliding of an adsorbent pad, to contain amounts of liquid, to keep small parts from rolling or sliding away (e.g., bottle caps, the precision cutting tools sold under the trademark X-ACTO knives by Elmer's Products, Inc. (Westerville, Ohio), etc.). As shown in FIG. 2, unit 101 includes back panel 309 that can provide information. Unit 101 may further include book storage caddy 371, a scanner or mount for a scanner in position 363, or a screen 361. Sensor or scanner tools are described in U.S. Pat. No. 7,303,080; U.S. Pub. 2010/0131097; and U.S. Pat. No. 6,995,673, the contents of each of which are incorporated by reference in their entirety.

Unit 101 may include storage areas for personal protective equipment PPE such as goggles 381 or gloves 383, as well as materials for disposal such as bags 385, reagents, or other materials. For example, glove and goggle caddies 381 and 383 (“at the ready” compartments) for PPE are to the far left; waste disposal bags 385 to the near left; book, pamphlet, and manual storage 371 is in the center above recessed work area 375 which particularly includes absorbent pad landing 367; and pad storage 377 for additional absorbent pads is to the right. This disposition of features supports a natural work flow and good compliance with material handling protocols by employees.

In some embodiments, the invention provides a process for safely handling hazardous wastes that includes receiving mixtures of waste at a unit that includes material storage arranged in order of routine use (e.g., left to right). By putting the PPE, for example, in the first position that a user logically or habitually looks when beginning to use the unit, good safety practices including consistent use of PPE is encouraged. By providing a recessed work area 375 in the center that spatially fits and visually appears to fit adsorbent pads, the pads are used and hazardous liquids are absorbed and disposed of properly (rather than spilled to the floor, for example). By positioning the work area immediately beneath storage 371 for informational signs, books, pamphlets, and binders, users are naturally encouraged to habitually consult the information contained therein, including simple illustrations of waste being handled properly, and this encourages consistently safe handling practices. In some embodiments, unit 101 is organized so that work flow proceeds right to left, depending, for example, on the local circumstance. Devices for handling materials are discussed in U.S. Pat. No. 5,868,709; U.S. Pub. 2010/0007250; U.S. Pat. No. 7,762,565; U.S. Pat. No. 6,378,963; U.S. Pat. No. 4,637,545, the contents of each of which are hereby incorporated by reference in their entirety.

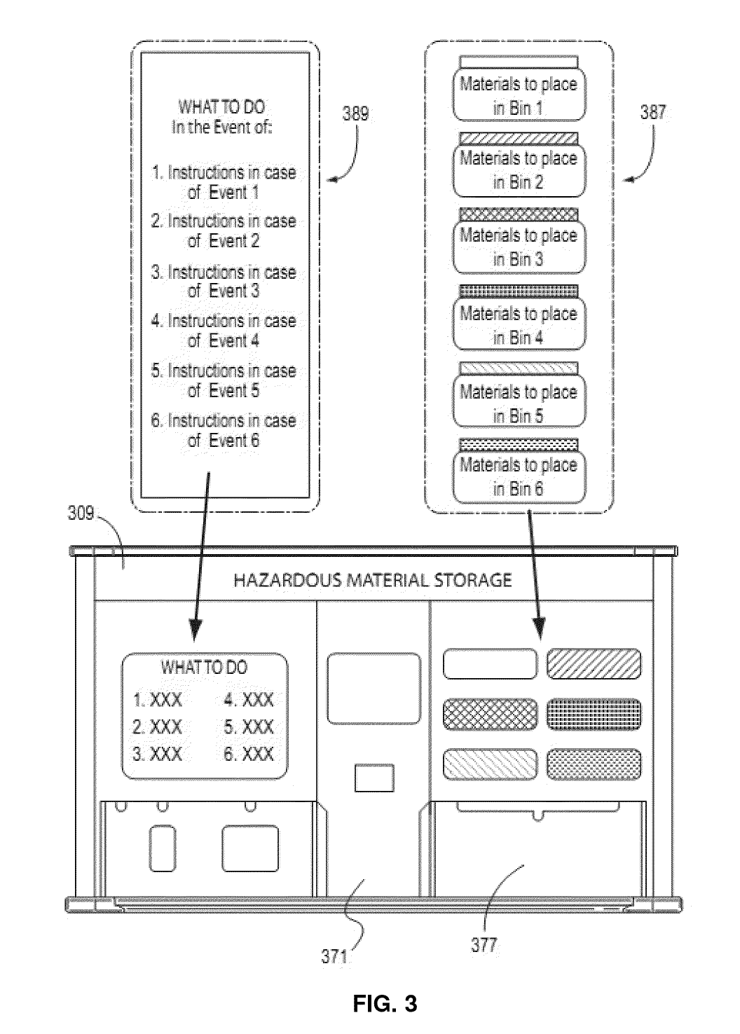

FIG. 3 shows use of back panel 309 of a unit 101. Panel 309 can include essential safety information or instructions, or can call attention to the role of unit 101 in a firm's overall safety, disposal, and environmental mitigation protocols. In certain embodiments, slot 371 is dimensioned to hold a binder. Such a binder may include safety information, a log, or other materials. FIG. 3 shows example materials that can be displayed such as instructions or warnings in area 389 (e.g., provided by a decal, card, sticker, or other display). Similarly, information can be shown in area 387. In some embodiments, one of area 389 or area 387 is a screen such as a monitor. A screen can show information, for example, in a dynamic fashion (e.g., responding to scanning of a product by a user, scrolling through preset information, or accessible via a computer interface such as a browse-able touch screen).

Waste handling according to the invention may proceed by receiving one or more containers of waste at unit 101 (for example, onto work area 315). A user may determine which bin the container of waste should be stored in by, for example, referring to information on back panel 309. The user may then place a container of waste in a bin 331.

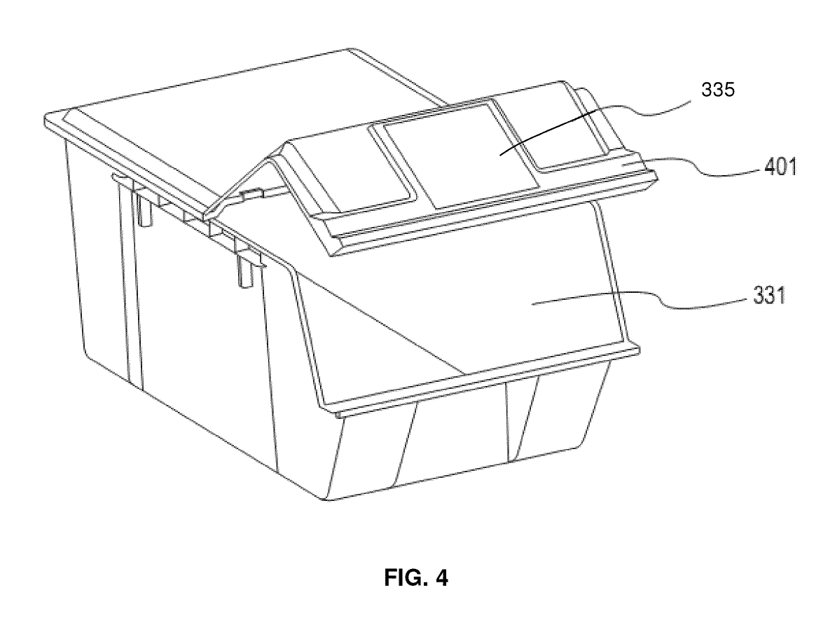

FIG. 4 shows a detail view of bin 331 according to certain embodiments. Bin 331 generally includes see-through lid 401 which can be, for example, semi-frosted, to reveal, for example, a fullness of bin 331. In various embodiments, lid 401 is transparent, translucent, or opaque on one, a few of, or all of bins 331 in any given unit. Lid 401 can include a carrier 335 for a label. A handle portion of lid 401 may be a separated piece of material that snaps into place. In some embodiment, the separate, snap-on handle is color-coded to match categories shown on screen 387.

Since a user can see through lid 401, a user has a natural indication of when a bin is nearly full and a pickup should be called for. A user is also thus given a visual cue to aid in not over-filling bins (which could lead to personal injuries or environmental hazards). Further, lid 401 may include a label carrier 335 in which a label can be positioned such as, for example, a label compliant with the U.S. Resource Conservation and Recovery Act (RCRA) labeling requirements. A bin may have a fill line, for example, within the bin, on lid 401, or printed on a label in carrier 335. Any of bin 331, lid 401, or label in label carrier 335 can include one or more fill lines (e.g., etched or printed on). In some embodiments, a bin includes at least two fill lines (on the inside or outside of any suitable surface)—a first fill line labeled “order pick up now” and a second fill line labeled “do not fill past this point”.

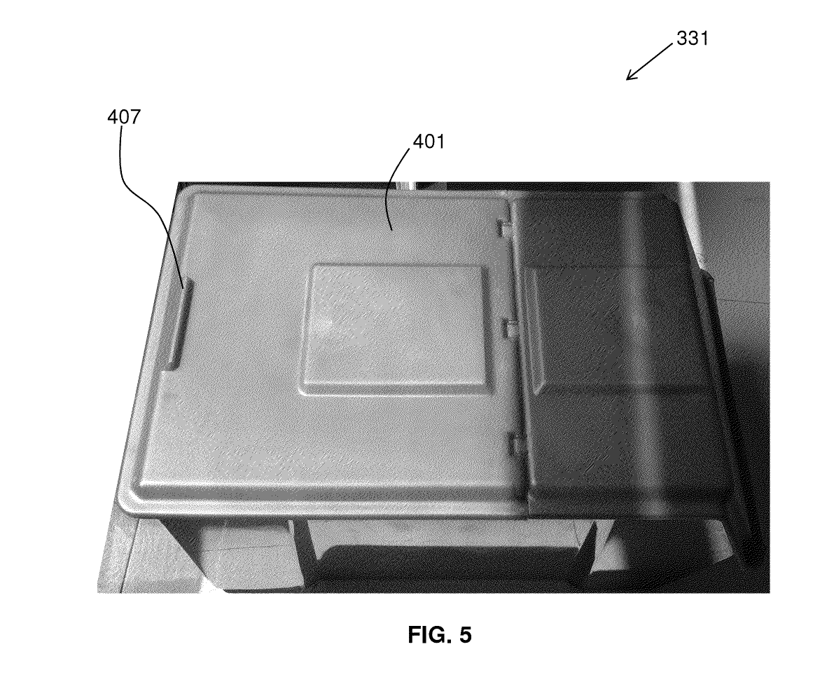

FIG. 5 shows a side-view of a bin 331 according to embodiments. As bin 331 is slid forward from unit 101, it is supported as a cantilever. Stop 407 prevents a worker from withdrawing bin 331 to the point that it falls (e.g., onto a person).

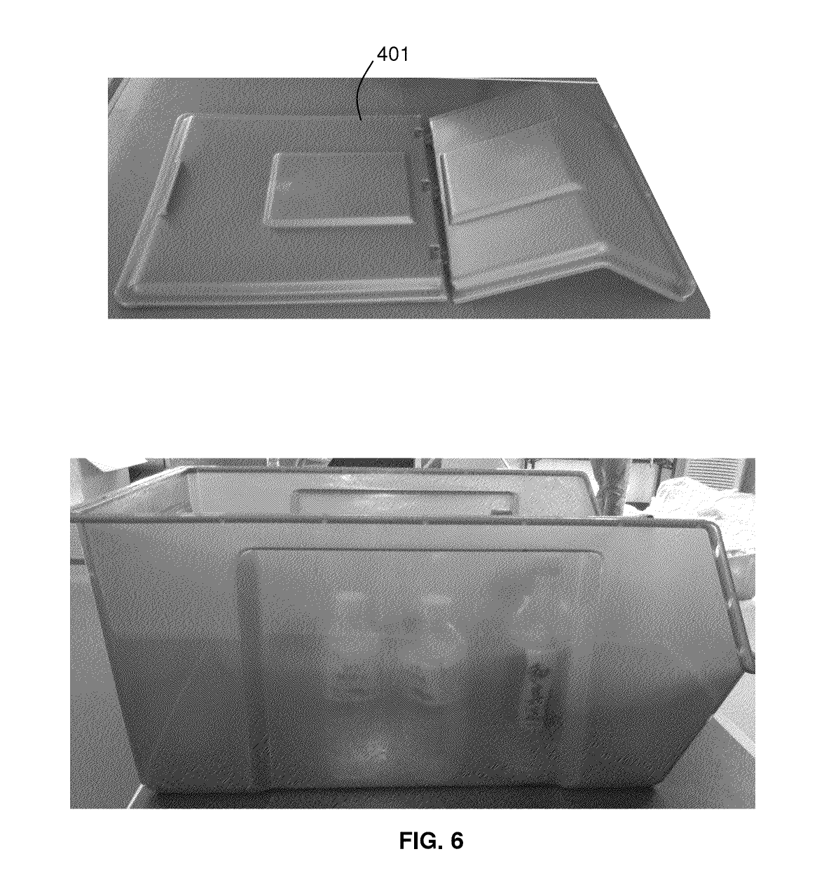

FIG. 6 shows lid 401 separated from bin body 331. Bins 331 are stackable and nestable. The morphology of the bins aids in clean, straight stacking and nesting. Moreover, lid 401 and bin 331 include slots and grooves so that lid 401 can slide onto the bin, and then be opened and closed by lifting around a hinge axis (three hinge elements are visible in FIG. 6, where the two components of lid 401 meet each other). Moreover, as shown in FIG. 6, lid 401 does not have snap-on color-coded handle or label carrier 335 snapped into place. In some embodiments, those are provided as separate, snap-on components.

As can be seen in FIG. 6, bin 331 allows typical commercial bottles and packages to be placed therein, for example, standing upright. In fact, six of a gallon container, such as would contain bleach, fit within bin 331. It has been found that such a unit as shown in FIG. 1 containing six such bins 331 is well suited to a typical retail store (e.g., pharmacy or home improvement store) with, for example, a bi-weekly pickup schedule (or weekly or monthly). In some embodiments, one or more of bin 331 are provided that fasten closed so that if tipped and knocked to the floor, contents do not spill out.

In certain embodiments, a lid 401 on bin 331 has a gasket to prevent the release of vapors from bin 331. This may be employed where, for example, turpentine or other noxious wastes are to be stored. In some embodiments, one or more of bin 331 is provided that is designed to prevent contact between the contents of the bin 331 and humans, such that it is essentially impossible to accidentally touch the contents. Further, where—for example—controlled substances are involved, the bins may actually be secured or monitored.

Aspects of the invention provide methods for waste handling in which it is recognized that an overall process of waste handling includes multiple different phases, any or each of which may be suited to different tools or tools that include suitable features.

In general, a first phase of waste handling involves people gaining knowledge of waste. A wholesale supplier may recall all cartons of a certain product (e.g., turpentine). A customer may return unused paint. A store employee may damage a package and need to dispose of it.

In a second phase, a person handling the waste will gain information about the waste, for example, by reading on a sign that bleach and ammonia must be stored separately, or that turpentine must be stored in a container with a gasket. The person may then process the waste, for example, wiping dirt off of the container or tearing off a label. The person will also sort the waste, directing the container of waste to an appropriate bin 331.

Using a unit 101 of the invention, if a bin 331 is full, a person may remove the bin from the carriage. However, security can be adapted so that only certain individuals can remove the contents from the bins. Multi-phasic handling gives the retail employees (the protected) the freedom to do their jobs, while fully protecting them and also not patronizing them or insulting their intelligence.

In certain embodiments, unit 101 contains several bins 331 of differing characteristics that can be removed from the unit with one level of security (e.g., none) but that secure access to their contents by another level of security (e.g., key required). By these means, the safest thing to do is the easiest thing to do. In some embodiments, personnel have the ability to empty the unit (i.e., swap out bins) but not the ability to empty the bins. Security is organized for multi-phasic handling.

Use of a unit 101 facilitates party role partitioning. A retail employees can use unit 101, for example. The servicer contractor can remove, clean, or replace unit 101 and bins 331. In some contexts, waste handlers are categorized by role, which can include, for example, handler (can be divided, e.g., into small and large, and refers to those that accumulate universal waste); transporter; and destination facility. Transporters transport universal wastes from handlers to other handlers, or destination facilities. Destination Facilities treat, dispose, or recycle universal wastes. In certain embodiments, a unit 101 is used by retailer that is a handler. In some embodiments, a unit 101, or bins 331, are collected from the handler by a transporter.

Bins 331 can be swapped out by different participants in the multi-phasic waste handling process. For example, a retail employee may fill bin 331 (e.g., by opening hinged lid), while a registered EPA transporter may swap out a full bin for empty one.

In some embodiments, a unit 101 integrates with downstream systems. For example, bins 331 of unit 101 may correspond to categories such as government regulatory categories (e.g., categories tracked in EPA hazardous waste manifest-based tracking systems). Labels in caddy 335 on the lids 401 of bins 331 can have, for example, information corresponding to EPA uniform hazardous waste manifest rules. In some embodiments, labels on bins 331 can have barcodes that can be scanned transporter personnel to automatically import information into the transporter's computer system.

Unit 101 and its components may be manufactured by any suitable method and from any suitable material. For example, components may be made by injection molding, stereolithography (e.g., for good finish and accuracy), direct metal laser sintering or selective laser sintering (e.g., for impossible to mold topologies), fused deposition modeling, computer numeric control (CNC) machining, laminated object manufacturing (LOM), three dimensional printing (3DP), casting, urethane casting, vacuum forming (e.g., for lightweight or water clear polyethylene or opaque materials).

Exemplary materials for unit 101 may include, for example, plastics or other molded polymers. For example, in some embodiments, unit 101 is made with acrylonitrile butadiene styrene (ABS), polypropylene (PP), poly(1,2-propanediyl phthalate) (PPP), aluminum, medium-density fiberboard (MDF), or a combination thereof. The plastic components can be ABS or PPP. Aluminum can be used to provide structural rails along the length of the unit, to support surfaces. Further, MDF can be used as a panel, such as a printed side-panel. Use of ABS is discussed in U.S. Pat. No. 4,746,008.

Other suitable materials for components of unit 101 include polycarbonate, acrylic, poly(methyl methacrylate) (PMMA), polystyrene, polydimethylsiloxane (PDMS), polyvinyl chloride (PVC), santoprene, polypropylene, rubber-like urethanes, sheet metal (e.g., spring steel, aluminum, steel, copper and brass), rigid or flexible vinyl, polyurethane foam, acetate, polyethylene, color coded shim stock, Mylar, Kapton, Teflon, and Nylon, or similar. Some such materials are available, for example, from Die-Cut Products Co. (Cleveland, Ohio). Suitable materials for components of unit 101 further include UHMW polyethylene film or PTFE film, LDPE, MDPE, and polytetrafluoroethylene such as that sold under the trademark TEFLON and made by E.I. Du Pont De Nemours and Company (Wilmington, Del.). In certain embodiments, a rubber gasket is included for vapor containment, for sound dampening, or aesthetics. Suitable rubber and related materials include, without limit, natural rubber, EPDM, EPT, EPR, SBR, neoprene, nitrile, millable gum, epichlorohydrin, Silicone, polyacrylate, flourisilicone, butyl rubber, and flourelastom, which materials are available from firms such as Bloomer Plastics, Inc.

In various embodiments, any of information panel 335, back panel 309, side panel 317, area 207, or a combination thereof may include fiberboard, paperboard, cardboard, plastic, laminate, or a corrugated material. Exemplary corrugated materials include cardboards, fiberboards, plastics (e.g., coroplast or any of the corrugated plastic sheeting sold under the trademarks INTEPRO, CORREX, or TWINPLAST), and stiff fabrics and can include any of A-Flute through F-Flute construction. In some embodiments, a plastic material is included having an SPI resin identification code of 5 or lower, or 4 or lower.

In some embodiments, unit 101 is made with recycled material, thereby increasing an appeal to the environmentally minded consumer while also offering the manufacturer a sustainable product to make and sell, allowing the manufacturer to provide products for longer into the future. Units according to the invention can further be made with material that decomposes readily or harmlessly, such as photodegradable or biodegradable materials. In some embodiments, unit 101 includes a photodegradable material. An exemplary photodegradable material for incorporation into unit 101 is low-density polyethylene, although any photodegradable material may be used, for example, as described in U.S. Pat. No. 4,042,765, incorporated by reference herein in its entirety.

In certain embodiments, a plastic material includes an additive to encourage the plastic to degrade such as the additive sold under the trademark ECOPURE by Bio-Tec Environmental LLC (Albuquerque, N.M.). When such a biodegradable plastics additive is mixed into raw plastic (e.g., at less than 1%), it allows that plastic to break down when placed in a microbe rich environment, such as a landfill or compost facility.

Other features and aspects of the invention may be included in various embodiments. For example, in some embodiments, one or more of bin 331 are made of fiberboard for collecting a waste, so that bin 331 may be recycled or incinerated along with the waste. In some embodiments, a bin 331 has puncture-proof walls for collecting sharp objects such as biohazard sharps. One or more of bin 331 may have a lock to secure waste items that have theft potential. In some embodiments, unit 101 includes a computer device, optionally including a scanner or camera, to aid in identifying a category of material and provide instructions for its handling. Systems and tools for handling materials are discussed in U.S. Pat. No. 7,096,161; U.S. Pat. No. 7,454,358; U.S. Pat. No. 6,097,995; U.S. Pub. 2006/0036407; U.S. Pub. 2011/0259467, the contents of each of which are hereby incorporated by reference in their entirety.

In certain embodiments, unit 101 includes a scanner, for example, a camera to image a material or a barcode scanner or an image capture device, e.g., to capture an image of a QR code. Scanning information can allow an included computer device to provide information about the material. For example, in a pharmacy-type setting, bottles can be labeled with codes indicating contents, and scanning the bottle can cause screen 361 to display instructions for disposal that comport with laws, safety, corporate objectives, or best practices.

In some embodiments, one of bin 331 is securely locked with a “one-way” (e.g., in only) access port for the containment or disposal of controlled substances. Another of bin 331 can be very easy to remove and empty and can be a designated destination for very innocuous substances. Another of bin 331 can be made of non-reactive material and can be a disposal bin for certain reactive chemical substances.

In some embodiments, bins 331 and information signage on unit 101 relate to categories of universal wastes. Universal wastes may include, without limit, used batteries such as nickel-cadmium (Ni-Cad), mercuric-oxide, lead-acid batteries, or lithium batteries, found in many items common to small businesses and households (these batteries are from such items as electronic equipment, cellular telephones, portable computers, and emergency generator backup lighting); fertilizers, pesticides (agricultural or household bug sprays), or other similar chemicals; mercury-containing items, such as thermostats, barometers, thermometers, certain gages, and electrical switches, or any items containing elemental mercury; spent lamps such as fluorescent, high-pressure sodium, mercury vapor, and metal halide lamps that are located in commercial, industrial, agricultural, community and household buildings; or electronic items such as cathode ray tubes or other electronics. Electronic items are electronic equipment that contains one or more circuit boards or other complex circuitry. Examples of electronic items include laptop computers, telephones, radios, keyboards, and stereos. They also include components and subassemblies or other parts derived from the disassembly of electronic items.

Units and methods of the invention may be employed to safely handle universal wastes such as those generated by small and large businesses, governmental agencies, not-for-profit organizations, schools and colleges, charitable organizations, churches, farms and ranches, households, communities and hospitals. Locations for units 101 may further include one or more of a pharmacy, home improvement store, consumer electronics store, car dealership, department store, service station, household goods store, toy store, shopping mall, office complex, apartment or condominium complex, municipal waste transfer station, or other facilities. The needs of any particular location can be assessed, and a unit can be assembled to include components corresponding to needs of the particular location. For example, a large store with high volume may be provided with two units to sit side-by-side including a total of 12 or more disposal bins. A store that traffics in a lot of controlled substances may be provided with a unit that includes a number of bins secured by a lock (e.g., bins with a small inlet port for pills).

In some embodiments, units of the invention include components (e.g., bins, labels, bags, etc.,) that comply with US Department of Transportation (USDOT) packing, labeling, or marking regulations. The USDOT regulates hazardous and non-hazardous materials in all modes of transportation (highway, air, water, rail). While the USDOT is concerned with loading, movement and transport, and not with storage before transport, the use of specific waste containers, labels, marking, and vehicle placards during initial collection and sorting aids in comploying with DOT regulations in downstream handling. Relevant regulations can be found Title 49, parts 100-199, of the Code of Federal Regulations, the contents of which are hereby incorporated by reference in their entirety.

In some embodiments, unit of the invention include components adapted to comply with RCRA and related rules such as, for example, U.S. EPA requirements for labeling and manifesting of hazardous waste. Units of the invention can be adopted to work with waste tracking systems such as those discussed in U.S. Pub. 2012/0158607, the contents of which are hereby incorporated by reference in their entirety for all purposes.

In various alternative embodiments, a unit 101 may optionally include a sink; liquid receptacle vessel; liquid reservoir or vessel; a vents or ventilation duct (e.g., tubes, hoses, or air ducts leading away); wheels or lockable casters; or a combination thereof. Unit 101 may be adapted for the handling of food waste, biohazard waste, sharps, recyclables, or other chemicals. For example, where a site needs liquid handling and washing capabilities, a unit may include a sink and one or more sources of liquids such as hot or cold water, detergents, or other reagents. Where a site needs biohazard/ sharps handling capabilities, a unit may be provided with a sharps bin 331. A unit of the invention can be installed on-site or can be portable. In some embodiments, a unit has wheels, for example, as casters, allowing the unit to be easily rolled. A unit may provide dedicated compartments (e.g., bins) for different classes or categories of waste including, for example, toxic waste, pressurized gas, flammable materials, reactive materials, corrosive materials, pharmaceuticals, recyclables, trash, compost, food waste, or others. Compartments are discussed in U.S. Pat. No. 7,044,569; U.S. Pub. 2009/0294312 and U.S. Pat. No. 7,341,147, the contents of which are hereby incorporated by reference in their entirety. In some embodiments, bin 331 is be provided with a known tare weight so that bins can be weighed during transfer from unit 101 to a transporter vehicle with the result that the weight of the contents is provided for tracking purposes. In some embodiments, unit 101 is smaller or larger than shown, for example, in FIG. 1. For example, unit 101 can be 1 bin wide by 2 bins tall (2×1). In certain embodiments, unit 101 is about ⅔ of the length of the unit depicted in FIG. 1 (e.g., 2×2 instead of 2×3). In some embodiments, unit 101 is longer, such as 2×4 or 2×5. In some embodiments, a desktop-style unit 101 is provided having only one bin (1×1) or the height of one bin and the width of two or three (1×2 or 1×3).

### Incorporation by Reference

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A device for handling materials comprising:
a plurality of bins to receive and store containers of hazardous waste; and
a cabinet housing the bins and providing a work area comprising tool storage and information about waste handling using the bins.

2. The device of claim 1, wherein the bins are interchangeable and removable.

3. The device of claim 1, wherein at least one of the bins comprises a see-through lid.

4. The device of claim 1, wherein the tool storage is arranged so that tools stored therein are used in order from left to right by a person storing a container of hazardous waste in one of the bins.

5. The device of claim 4, wherein the tool storage is adapted to store gloves and goggles at the left-most position, as well as disposal bags and printed information in other positions.

6. The device of claim 2, wherein the bins comprise stops structures to prevent the bins from being slid completely from the unit.

7. The device of claim 1, further comprising an absorbent pad landing.

8. The device of claim 1, wherein the information is a sign.

9. The device of claim 1, further comprising a computer device comprising a memory coupled to a processor, wherein the processor is configured to receive information about a material and provide information about handling the material.

10. The device of claim 1, wherein the bins comprise label carriers with labels inserted therein, and further wherein the labels relate to categories of hazardous waste.

11. A process for handling materials comprising:
providing a device having a plurality of bins;
receiving at the device a plurality of containers of hazardous waste;
providing, via the device, a work area comprising tool storage and information about waste handling using the bins; and
receiving each container of hazardous waste into one of the bins.

12. The process of claim 11, wherein the work area comprises a plurality of compartments, each containing a safety tool, arranged in order of use during a materials handling and sorting event.

13. The process of claim 12, wherein the safety tools include gloves, bags, and informational printed materials.

14. The process of claim 11, further comprising providing a plurality of the devices to different facilities.

15. The process of claim 11, further comprising transferring the contents of the plurality of bins to a vehicle.

16. The process of claim 11, wherein the device further comprises a computer device comprising a memory operably coupled to a processor and the method further comprises receiving information about each material into the memory.

17. The process of claim 14, further comprising transferring the information to an additional computer device.

18. The process of claim 15, wherein the transferred information identifies the contents of a pick-up.

19. The process of claim 13, wherein the bins are dimensioned to each store six one-gallon-sized bottles.

20. A waste handling unit comprising:
a housing unit;
a work area on the housing unit comprising a horizontal surface;
one or more bins housed in the housing unit and adapted to be removed and replaced; and
a caddy for storing a tool.

21. A method of safely collecting waste, the method comprising:
assessing the waste stream of a plurality of locations;
assembling a collection unit for each of the plurality of locations by providing each unit with an assortment of collection bins that correspond to the waste stream of the corresponding location;
providing each collection unit to the corresponding location; and
unloading collected waste from each collection unit.

22. The method of claim 21, wherein each of the plurality of locations is a pharmacy.

23. The method of claim 21, wherein unloading comprises dumping the contents of the bins into transporter bins.

24. The method of claim 21, wherein unloading comprises swapping out the full bins in the units for empty bins.
